(19) United States
(12) Patent Application Publication
(10) Pub. No.: US 2014/0032555 A1
(43) Pub. Date: Jan. 30, 2014

(54) SYSTEM AND METHOD TO CLASSIFY TELEMETRY FROM AUTOMATION SYSTEMS

(71) Applicants: Liana Maria Kiff, Minneapolis, MN (US); Henry Chen, Beijing (CN); Ashley Noble, North Ryde (AU); Adam Gibson, Brunswich (AU); Ben Coleman, North Ryde (AU); Gary Fuller, North Parramatta (AU); Conrad Bruce Beaulieu, Duluth, MN (US); Keith Johnson, Plymouth, MN (US); Michelle Raymond, St. Louis Park, MN (US)

(72) Inventors: Liana Maria Kiff, Minneapolis, MN (US); Henry Chen, Beijing (CN); Ashley Noble, North Ryde (AU); Adam Gibson, Brunswich (AU); Ben Coleman, North Ryde (AU); Gary Fuller, North Parramatta (AU); Conrad Bruce Beaulieu, Duluth, MN (US); Keith Johnson, Plymouth, MN (US); Michelle Raymond, St. Louis Park, MN (US)

(73) Assignee: Honeywell International Inc., Morristown, NJ (US)

(21) Appl. No.: 13/912,682

(22) Filed: Jun. 7, 2013

Related U.S. Application Data
(60) Provisional application No. 61/656,795, filed on Jun. 7, 2012.

(51) Int. Cl. G06F 17/30

(52) U.S. Cl. CPC G06F 17/30598
USPC 707/737

(57) ABSTRACT

A formal ontology includes multiple context elements to describe elements and their context within a system in the domain. The structure includes multiple role functions to describe the function of elements in the system, multiple types to describe values being provided by the elements in the system, and multiple states to describe states of the elements in the system, wherein the context elements, role functions, types, and states are selectable to provide a full description of the system.

### RELATED APPLICATION

This application claims priority to U.S. Provisional Application Ser. No. 61/656,795 (entitled SYSTEM AND METHOD TO CLASSIFY TELEMETRY FROM AUTOMATION SYSTEMS, filed Jun. 7, 2012) which is incorporated herein by reference.

### BACKGROUND

Most embedded control systems provide a limited way to address and name wired and unwired points of control or control variables, also called telemetry, which comprises the signaling used to monitor and control an electro-mechanical process. These variables are named by a human at the time of installation, and in some cases may follow a naming convention prescribed by the site where the system is installed, or by the application engineer or the manufacturer who provided the control solution. While there are some conventions that are common across an industry or within an application domain, wide variation occurs, and there is no single standard which can be counted on to deliver precise understanding of the configuration of the resulting system. Also, the terminology used will vary depending upon the local language (e.g., German vs English). Furthermore, regardless of localization issues, these named telemetry elements may lack sufficient contextual information to describe how they relate to each other within a system configuration.

The data represented by these systems is increasingly being used in higher-order analyses often supported by supervisory systems which may be centralized within an organization, or monitored remotely by a third-party. These remote solutions generally have no access to context information about the telemetry being delivered by the remote system. Given the wide variation in naming conventions and terminology used to describe telemetry, the telemetry may not be generally sensible to an electronic processing system, and may not be machine processable without human intervention or manual mapping to a more standard terminology.

### SUMMARY

A computer readable storage device has a meta-data structure stored thereon consistent with a domain ontology. The data structure includes multiple context elements to describe elements and their context within a system in the domain, multiple role functions to describe the function of elements in the system in relation to other elements in the system, multiple types to describe values being provided by the elements in the system, and multiple states to describe states of the elements in the system, wherein the context elements, role functions, types, and states are selectable to provide a full description of the system.

A method includes obtaining a description of elements in an existing system, identifying tokens from the description of the elements in the system, comparing the tokens with a lexicon derived from a domain ontology for describing the system in that domain, and mapping the tokens to specific roles utilizing rules of the domain-specific ontology.

### BRIEF DESCRIPTION OF THE DRAWINGS

FIGS. 1A, 1B, and 1C are block diagrams portions of a system of classification according to an example embodiment.

FIG. 2 is a chart illustrating a trie for use in finding tokens in sparsely documented sources according to an example embodiment.

FIG. 3 is a chart illustrating tokens and most likely matches according to an example embodiment.

FIG. 4 is a display illustrating roles of equipment identified from a domain according to an example embodiment.

FIG. 5 is a flowchart illustrating token extraction according to an example embodiment.

FIG. 6 is a flowchart illustrating automated context discovery according to an example embodiment.

FIG. 7 is a block diagram of a computer system for implementing one or more methods according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software stored on storage devices, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

Data represented by embedded control systems is increasingly being used in higher-order analyses often supported by supervisory systems which may be centralized within an organization, or monitored remotely by a third-party. These remote solutions generally have no access to context information about the telemetry being delivered by the remote system. Sometimes, the point name may contain human-readable information related to function, but this is not guaranteed, and it may not be presented in a fashion sensible to any other reader. Furthermore, it is not generally sensible to an electronic processing system, and may not be machine processable without human intervention or manual mapping to a more standard identifier.

The result is that a vast majority of the information created by control systems is incoherent outside its immediate programming context, and cannot be interpreted by a secondary processing system without expensive manual intervention during the initial configuration of the secondary system. In many cases, this can be such an expensive process that it becomes prohibitive to acquire and mine that data.

An ontology includes entities, attributes, and relationships that describe a specific domain. The entities and formalisms in the ontology together support a means to strongly type the data relating to that domain. The ontology is a semantic formalism that describes meta-data (data about data) that describe a domain. The ontology may further be used to describe instances of domain objects consistent with this ontology, and ruled by the formalisms therein, such that reasoning may occur across the elements so defined. The domain ontology and the instance ontology can be described using public standard representations (e.g., OWL and RDFS) and instances adhering to the model may be defined in similar fashion (RDF) and validated against the meta-model (RDFS). This data may also be supported by a persistence model via a flat file, database, or file storage mechanism for storage and processing.

In various embodiments, an ontological system is used for describing mechanical and environmental factors related to environmental control, as supported by an electro-mechanical devices within a building (air handling systems, boilers, chillers) or other equipment designed to control environmental factors in enclosed spaces, and other factors related to, but not specific to the mechanical systems (e.g., ambient conditions in the environment, occupancy of the building, function of the spaces so controlled). The data defined by this ontology allows every data element used or produced by the system to be unambiguously described in relationship to the system of which it is a part, or by which it is employed for the purposes of control.

One prior application of the ontology is to use that ontology to-define the design of a system when that system is implemented, and to communicate that design to consumers of data from that system.

A system and method facilitate classification and identification of the function of telemetry data. This system is made up of two primary parts, a formal classification system that is able to richly describe the significant factors that allow for correct interpretation of telemetry data, and a method to mine information encoded in naming conventions or descriptions to identify significant factors and process these with respect to an ontological model of the domain to identify the most likely interpretation for a piece of telemetry information.

By utilizing these tools, a significant portion of a formerly manual process may be automated to provide a consistent, human and machine-readable identification system to telemetry from embedded systems, which otherwise have no method to describe function consistently and coherently.

In various embodiments, a formal classification system facilitates a method to automatically identify and classify point functions such that an algorithm may be written to fully or partially automate the recognition of the function and purpose of telemetry data for automated, remote consumption.

Control systems are designed to control some process in order to deliver some service. Examples include delivering properly treated air, at the right temperature and in the right volume, to maintain a steady temperature in a closed environment. Another example includes controlling a complex industrial process to ensure that the right materials are combined in the right order, and treated in the right manner (mixed, heated, dried), to deliver a consistent product such as refined fuel, pharmaceutical, or other manufactured material. These are only two examples. Such systems are comprised of a plurality of equipment elements, product delivery conduits, and device controls which cause the equipment or the material to change state or behavior in some manner (e.g., heat or cool, move or flow, start or stop). The configuration of these equipment and control elements, commonly referred to as points, can be complex, and many configurations exist for similar processes, such that these elements may be combined in any number of unique combinations. The point names are often concatenated abbreviations for concepts in the process.

Various embodiments provide the ability to apply a method to describe control systems in such a way that the many possible configurations can be consistently identified, and so that each configuration can be reflected in the identification applied to the telemetry being received from the control system.

To accomplish this, a formal classification system may be implemented to order and structure conventions used to describe systems so that this structure can be used by automation systems to acquire and deliver data and services with a high degree of information coherence for both humans and machines.

The classification system is comprised of a number of discrete elements corresponding to meta-data that describes each point and its context:

PointContext: a means to describe the containment of a particular element by other elements significant in the organizational structure of the system

Plant context (what type of processing equipment/unit is being described)

Equipment context: What specific type of device is being described or controlled

Distribution Role: what type of function is performed

Material Type: What type of element is being measured, modified, consumed, or moved (e.g., water, oil, air)

Measure type: what property of a thing or process is being described (temperature, pressure, speed)

PIDRole type: what control function is being supported by this data (control, feedback (value), setpoint (target))

Signal type: Analog vs digital

Signal direction type(into or out of the controller (logical processor)

Statistic Type: values which represent an total over time, cummulative, minimum or maximum over a time range, or other similar derived value

Limit Type: values which describe a maximum or minimum expected value or other range limit

State type: values which describe a discrete state anticpated for an entity of a particular type

Building State type: Occupied or Unoccupied, Emergency, etc.

Equipment State type: On/Off, Enabled/disabled, StandbY

Point State type: Automatic, Manual, Alarm

Through the combination of these pieces of meta-data that describe the point and its context, each individual piece of telemetry is fully described in such a way that the collected telemetry itself provides a clear description of the configuration of the equipment with respect to the devices available in the solution, and their relative arrangement within a system of parts.

In the development of a control solution, one begins with small pieces of code that are designed to perform discrete tasks in very discrete contexts.

For example, one can write a control loop to control fan speed, without knowing where the fan will be placed, or why the air is being moved. At this level of programming, one need only know that there is a speed control (analog electrical output to the fan) a speed setpoint (desired speed) and a way to measure the effect (air flow). These bits of telemetry can be identified by their measure type (power, speed, volumetric rate of flow), and their source or target (a fan). No other knowledge is necessary to one skilled in this art to understand that the controller works in isolation on these elements of information.

The actual fan, however, plays a role in a larger solution. In a large air-handling system for comfort control, the fan could be placed in one of several discrete locations in the system, such as in the return air duct, the supply air duct, or the exhaust air duct. This role within the system (Supply, Return, or Exhaust, for example) is critical to understanding the purpose of the fan in the system as a whole. This role is not known until an application designer composes the control solution for the entire system, linking many such discrete control loop elements into a functioning whole. As each piece is added, its role is identified. Once identified by such systematic means, these data can be readily used by other control applications, so that these new applications can be applied directly without human intervention and customized manual programming to a specific hardware/control instance.

These data can then also be subscribed to by external systems to provide analysis services. Examples of such systems include advanced diagnostics, and energy management solutions which may draw relationships between equipment which is related by some other context defined by the domain, not only the specific control function for which it was originally installed.

While some aspects of control have been described by other standards (Building Information Model / Industrial Foundation Classes, and Green Building XML), no existing standard is sufficient to address the full variability of system configurations, and none are comprehensive enough to be used to address the needs of both the control engineer and the energy analyst, much less provide for the ability of external systems to draw relationships.

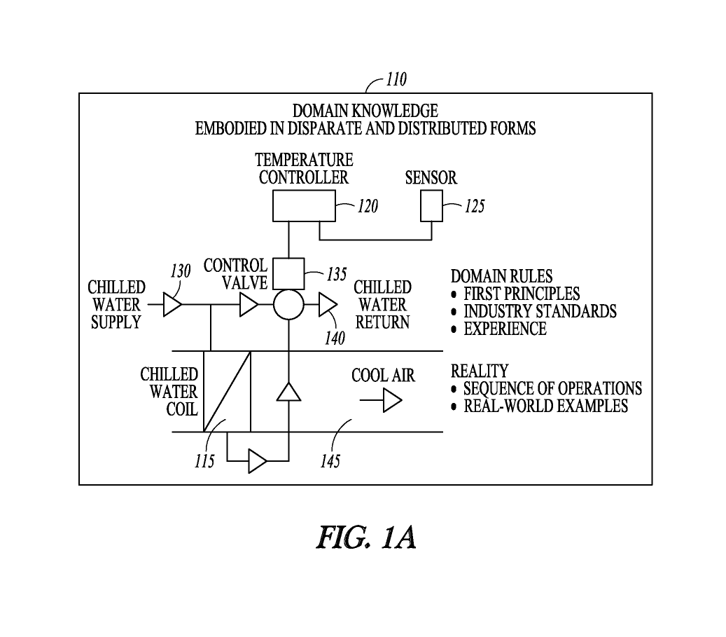

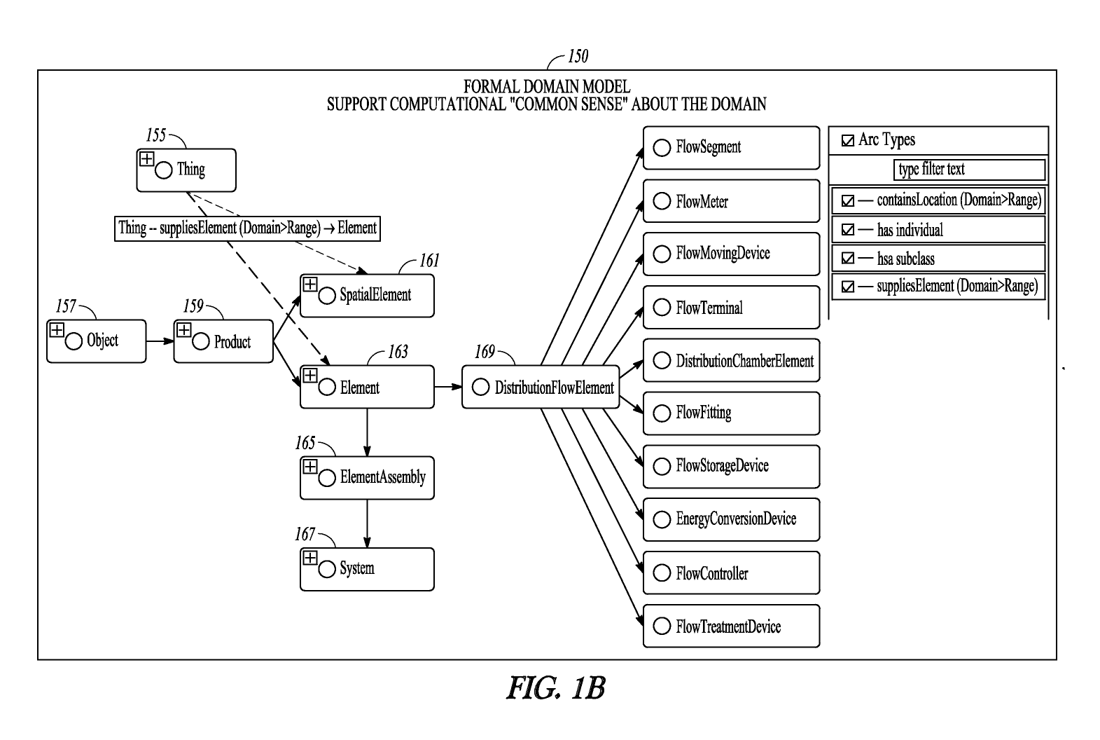

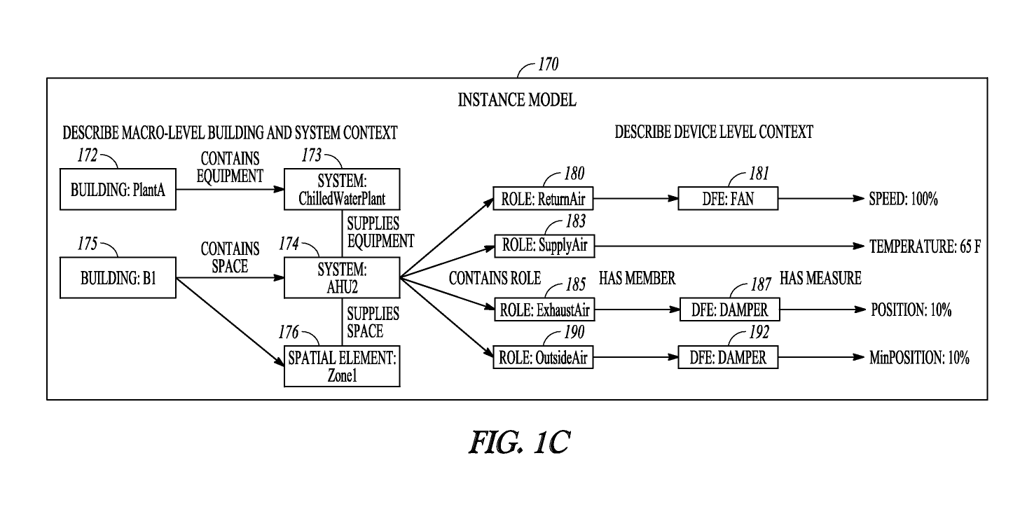

Applying the system of classification during a control system configuration leads to a specification of the control system that is immediately useable in higher order analysis systems. One example of a system of classification, also referred to as an ontology is shown in block form in FIG. 1B generally at 150. The model illustrated is a portion of the IFC standard, modeled as an ontology. An ontology is one type of formal information model that supports the collection and application of appropriate contextual information about a domain that can be applied to reason about the domain. An ontology is a highly ordered and precise model and contains strongly typed information regarding a domain. A typical graphical representation of domain knowledge is indicated at 110 in FIG. 1A for one particular simplified system to cool air using a chilled water coil at 115. The representation consists of a block flow diagram with labeled elements and illustrated connections in relation to the elements. Further elements in the domain model include a temperature controller 120, temperature sensor 125, chilled water supply 130, control valve 135, chilled water return 140, and cool air outlet 145. The domain elements may be further defined by other unstructured data artifacts about the domain such as the sequence of operations of elements within the domain and control algorithms.

A formal domain model is indicated at 150 and supports computational common sense about the domain. An element is represented as a thing 155 in the formal domain model 150. The domain includes an object 157, product 159, spatial element 161, element 163, element assembly 165, system 167, and distribution flow element 169. Several different distribution flow elements may exist in the model, including flowsegment, flowmeter, flowmovingdevice, flowterminal, distributionchamberelement, flowfitting, flowstoragedevice, energyconservationdevice, flowcontroller, and flowtreatmentdevice. These elements may be further subclasses until they represent uniquely defined types of things that may appear in the real world.

An exemplary instance model, which describes the arrangement of real-world objects, for the domain 110 is illustrated at 170 in FIG. 1C and describes a macro-level building and system context. At 172, a real building is indicated as PlantA, which contains real equipment in the form of a system chilled water plant 173 while supplied equipment AHU2 at 174 in BuildingB at 175. The AHU2 174 supplies a space indicated as zone 1 of spatial element 176. AHU2 at 174 contains several roles with corresponding device contexts as indicated at return air 180 that is coupled to a distribution flow element (DFE) of type fan 181, role of type supply air 183 at a temperature of 65F, exhaust air 185 via a DFE damper 187 at a position of 10%, and a role outside air 190 via a damper 192 having a minimum position of 10%.

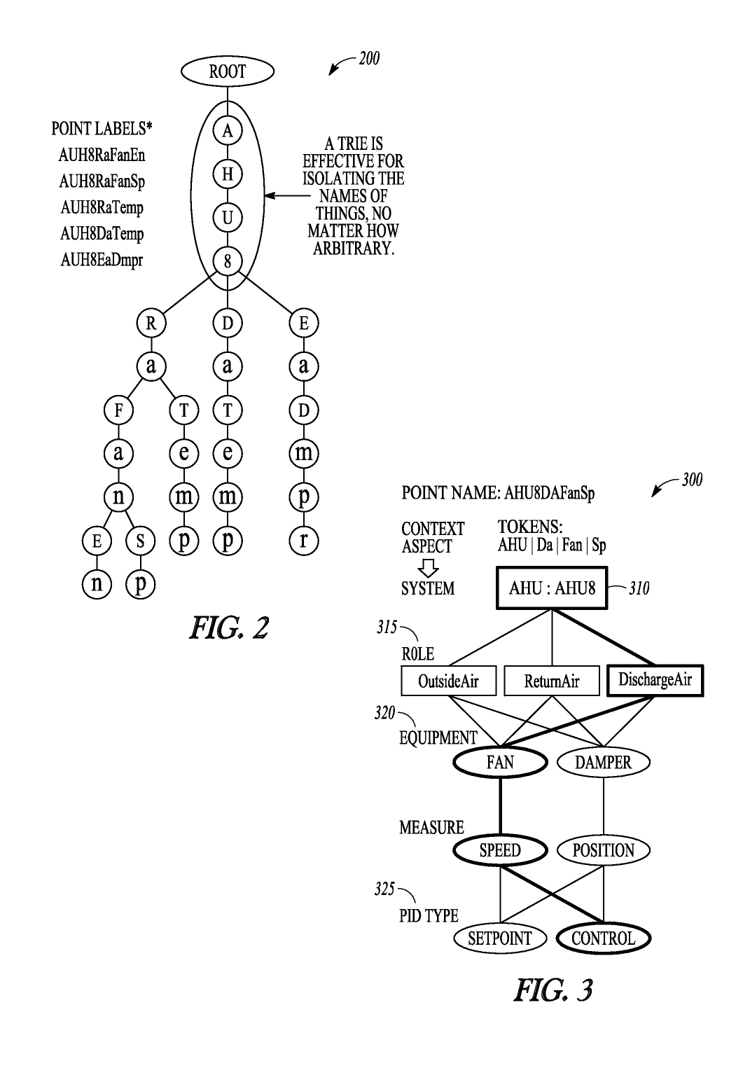

FIG. 2 is a diagram indicating a trie 200 which may be utilized to find tokens in sparsely documented sources, such as that illustrated in domain 110. While a trie is illustrated, other methods may be used such as queries against a relational database or XML database for example. The trie 200 provides a language independent means to identify meaningful tokens employed in an undocumented naming convention, even if those tokens are abbreviated forms of description. Several point labels are indicated at 200, such as AHU8DaFanSp. In one embodiment, each point label is matched to various domain concepts. For instance, the following concepts relate to various portions of the point labels:
AHU8 Identifier of some entity
AHU AirHandlingUnit
Da DischargeAir, Damper
Dmpr Damper
Fan Fan
Sp Speed, SetPoint

In this step a number of techniques can be used to produce a complete set of “potential” good matches. Each potential clue in the lexicon can be assigned a confidence level given the token match quality, with a confidence level decreasing in descending order in the following list:
Longer Tokens
Full match (Fan)
Contiguous Chars (Temp)
Capitalized Chars (Ea)
Ordered (Dmpr)
Shorter Tokens

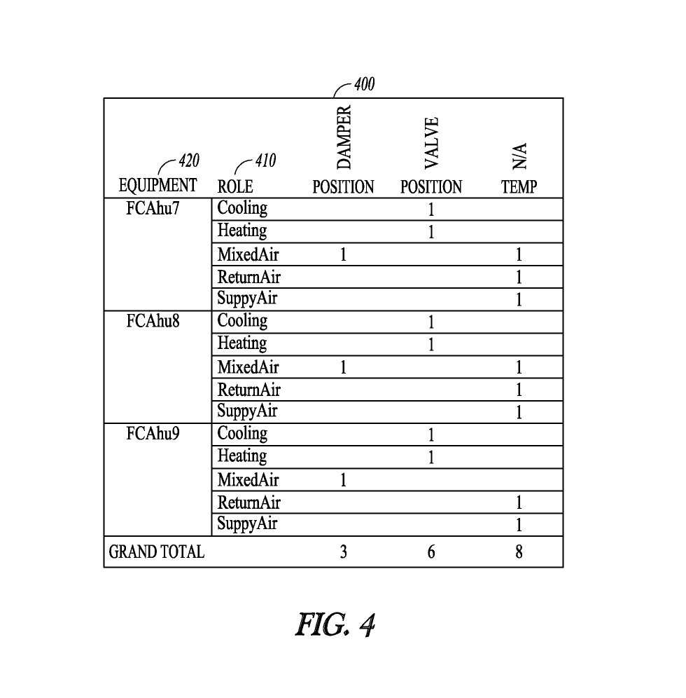

Domain rules may then be applied to dismiss the impossible combinations (combinations that are not allowed to exist in a given domain ontology). Given the point name AHU8DAFanSp, FIG. 3 illustrates the tokens and most likely matches at 300. At 310, a first token AHU8 corresponds to a context of system. A role of discharge air is then identified at 315 corresponding to token DA. At 320, the equipment may be either a damper (Da) or a Fan. Domain rules and confidence scores favor Fan as the correct match. At 321, Measure might be represented by Speed, for Sp. At 325, a PID (proportional/intergral/derivative) type is potentially indicated as a setpoint. In this example, the domain rules describe only one legal path, illustrated as darkened lines in FIG. 3, through the potential paths represented by the identified tokens. In such a solution, the relative positions of the tokens may also provide clues that reflect grammar or hierarchy in the domain, which further constrains the likely path.

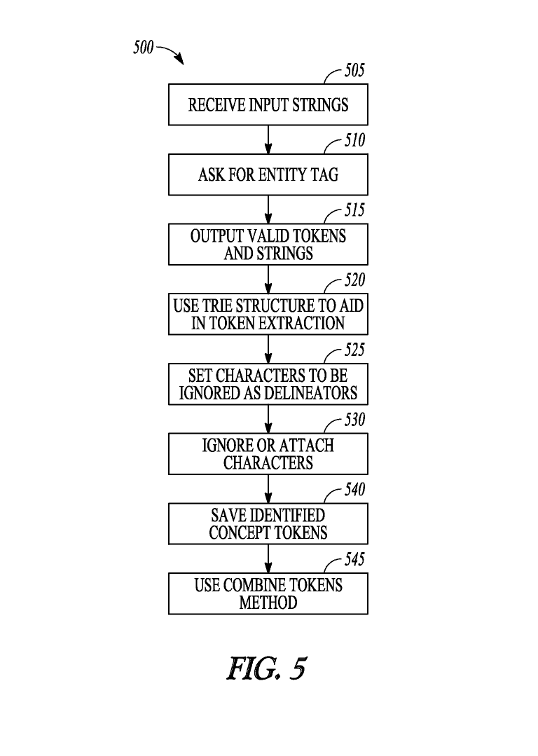

Once the context has been identified, it may be used by humans and machines to validate mappings, search and filter data, configure automation, generate displays, and present data succinctly. FIG. 4 is a diagram of a display 400 illustrating the roles 410 of various pieces of equipment 420 identified from a domain.

To establish the common vocabulary to describe systems in a domain, an ontology or domain model is used to describe the domain in question. A vocabulary may be used as the common semantic underpinning of the descriptive model.

Each domain and sub-domain may have its own vocabulary, though these vocabularies may relate back to more abstract concepts. Industry Foundation Classes provide one such example of a method of progressively modeling a domain at a sufficient level of detail for proper identification. Parts of this vocabulary, modeled in an ontological form, are illustrated in FIG. 1B.

A similar approach results in a set of vocabularies or ontologies specific to sub-domains of specific interest within a larger context, such as a building. In one embodiment related to controlling systems within buildings, these include power, lighting, and heating, ventilation and air conditioning applications.

The domain ontology provides the types, attributes and values that describe things and relationships in the domain, so that appropriate Roles can be supported that describe the function of data within that domain.

Automated context discovery utilizes unique data structures and formal models and transformation techniques to form intelligent models for points within a system. Given a list of points, in one embodiment, a Trie data structure is created, and numerous attributes are assigned to the nodes of the Trie, to allow various algorithms to parse the Trie for information, in order to build a set of possible concept tokens.

These tokens are compared to a lexicon, which is derived from an ontology, and the validated tokens can then be mapped into specific roles by applying rules of the domain described by the ontology.

One realization of this automatic context discovery is for use on point data for process control. The point names are often concatenated abbreviations for concepts in the process. For example, in HVAC control a point for the binary value of the digital input for the roof top unit number 3's return air fan, present value of the enabled state may be represented as ‘RTU3RaFanEn’.

For a variety of applications, such as energy analysis and fault diagnostics, the role a point plays in the system is important information. The point role gives context for the point value held by the process control system. The example point ‘RTU3RaFanEn’ has the following point role (concept set): DistributionFlowElementType is Fan, DistributionRoleType is ReturnAir, MeasureType is BinaryState, PIDRoleType is PresentValue, PlantType is RoofTopUnit, SignalDirectionTYpe is Input, SignalType is Digital and EquipmentStateType is Enabled.

The goal of automatic context discovery is to map each point needed by the application, generally a subset of all the points in the system, to their correct context. This is done by: 1) finding the concept tokens within the string that is the point name and/or point description, 2) mapping the tokens to potential concept terms, and 3) narrowing down which concept sets (pointRoles) are probable matches.

Unique and novel features for finding tokens include the algorithms applied to the Trie. Two algorithms of note are: (1) Children>X, (2) Traversal Count. These two algorithms provide a foundation onto which additional search, filter, and or extraction techniques can be used to find Tokens.

Unique and novel features for matching points to concepts in the ontology include regular expression matching of tokens to terms in the lexicon with a calculated confidence factor and conducting rule based filtering over the set of token matches for a given point.

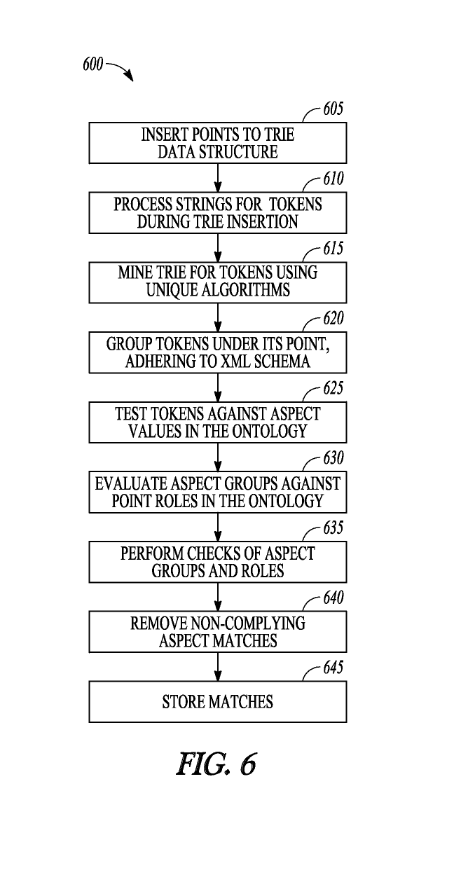

In a further embodiment, the following process 600 in FIG. 6 may be utilized to take advantage of the unique data structures to perform automated context discovery. Starting at 605, points (string of characters) are inserted to a Trie structure, and during insertion, at 610, the strings may be processed for tokens using particular algorithms which are more efficient to run at this stage, camelCase in one embodiment. At 615, the trie is mined for concept tokens utilizing the unique algorithms. Adhering to the XML schema, tokens from the various unique algorithms are grouped under a point at 620. The tokens are tested against aspect values held in the ontology at 625. Matching is performed using algorithms for regular expression matching and a confidence for each match is assigned based on the number of characters matched/percentage of characters matched, and effectiveness of the algorithm.

At 630, aspect groups are evaluated against point roles in the ontology. At 635, several checks may be performed, including a check that there is only one aspect of any aspect type, a check that aspect pairs can be in same group, and a check that the group of aspects is a subset of an existing point role. At 640, aspect matches that don't comply with the rules within the ontology are removed. Matches are then stored at 645.

The use of a trie structure aids in token extraction. A trie contains all strings with a single character at each node of the trie and number of leaf nodes equal number of strings. Nodes that have multiple children (Children>X) are candidates for delineation of the end of a concept token. Additional algorithms can set characters to be ignored as delineators. (example: ignore numbers, spaces and _characters) Per the algorithm, Ignored characters may be excluded from the resulting token or attached to either the closest token found in the parent part of the trie or the child part of the trie. Strings with token separation patterns, such as upper case letters, spaces or underscores, are candidates for delineation of the end of a concept token. Frequency of substrings within the set of strings can indicate the likelihood of that sub string being a concept token (Traversal Count).

The concept tokens found by analysis of the trie or other methods are saved in an accepted output format and a combine tokens method is used over all the output files. (Our realization does this through an XSLT transform.)

Lexicon creation utilizes a set of concept terminology that contain potential matches for the concept tokens (example: the concept AirHandlingUnit is a probable match for the concept token AHU in the HVAC domain.) For standards compliance the concept terminology has been represented in XML valid against the OASIS (organization for the advancement of structure information standards) Resource Information Model (RIM) schema. For quicker processing the RIM data has been transformed into XML valid against a new schema. Each term is stored in upper camel case format, but any standardized representation would work. (Example: the ‘air handling unit’ concept is stored as ‘AirHandlingUnit’.) The term used for a concept should be distinct within the whole set of terms. Terms may have abbreviations declared explicitly. (Example: the concept ‘Average’ may have ‘Avg’ declared as an abbreviation.) Abbreviations need not be distinct within the whole set of terms. (Example: both the concepts ‘Speed’ and ‘SetPoint’ may have the abbreviation ‘Sp’.) Terms may have alias terms that must also be distinct within the whole set of terms. (Example: the term ‘DischargeAir’ is often used for the concept ‘SupplyAir’). Terms may have abbreviations explicitly excluded. (Example: the concept ‘Energy’ is never abbreviated as ‘En’. Its abbreviations are usually derived from the alternate term ‘Consumption’.)

A concept set is a collection of concepts (concept terms). In a concept ontology there can be metadata for the concept terms. The simplest being the concept type. Example: for a pointRoles concept ontology the concept AirHandlingUnit is of type PlantType. Rules for allowable concept sets can be declared over the metadata. All terms of a given type are disjoint, which means that two concepts of the same type cannot both be included in a concept set. Example: AirHandlingUnit and RoofTopUnit are both of type PlantType so cannot be included in the same concept set.

A pointrole is a collection of strongly typed meta data that together provides an unambiguous description of the context of a given piece of data exposed in a control system. The pointrole allows values to be correctly interpreted for machine to machine communication and processing. A pointrole may refer to a hard-wired terminal, or to a software point or pseudo-point included in the software configuration of a device or system. A pointrole meta-model describes how elements of the definition of role are connected to the ontology, which aids in the interpretation of complex systems. It distills many complex relationships, both physical and virtual (software based control logic) into a manageable package. Aspects of the pointrole are not pointers to specific instances, but rather are references by type.

In one embodiment, a trie structure is used at 520 to aid in token extraction. Tries are commonly used to describe dictionaries of terms, for the purposes of supporting word-completion in word processing environments. The trie contains all strings in a given set of “words” and orders them with respect to their “spelling” or the pattern of the appearance of tokens within each string. With a single character at each node of the resulting trie and number of total leaf nodes equal to the unique number of strings in the set of original strings. Nodes in this Trie structure that have multiple children are candidates for delineation of the end of a concept token. A sub algorithm can set characters to be ignored as delineators at 525 by for example, ignoring numbers, spaces and _{—} characters). Ignored characters may be excluded from the resulting token or attached to either the closest token found in the parent part of the trie or the child part of the trie at 530. Strings with token separation patterns, such as upper case letters, spaces or underscores, are candidates for delineation of the end of a concept token. Frequency of sub strings within the set of strings can indicate the likelihood of that substring being a concept token. Numbers are typically indicative of ordinals that identify the names of instances of things in the real world (AHU2, AHU3).

For the example algorithms let the token t be represented as the characters c1, c2, . . . cn. For example, for ‘Fan’, c1=F, c2=a and c3=n). Represent the regular expression match as match(string, token, [I]) where the optional flag I indicates ignoring the case of the characters in the string and token.) Confidence levels in the examples are given as numbers for simplicity. A simple substring: match(string, c1 c2 . . . cn) has confidence level 9.5. A Simple substring at start of string: match(string, c1 c2 . . . cn) has confidence level 9.8. A simple sub string ignoring case: match(string, t, i) has confidence level 9. Order of letters: match(string, c1.* c2.* . . . cn) has confidence level 8

Order of letters capitalized: match(string, C1.*C2.* . . . Cn) has confidence level 9.8. Order of letters ignoring case: match(string, c1.* c2.* . . . cn, i) has confidence level 5. All matches are stored, regardless of their confidence.

The concept tokens found by analysis of the trie or other methods are saved in unique output files at 540 designating the tokenization methods, and may also be passed through a combine tokens method 545, via an XSLT in one embodiment, and then saved in an accepted output format at 545. In various embodiments, two formats (schema) are supported. One format orders the results using the point or original string as the principal organizing factor, with the extracted concept tokens discovered in that string ordered beneath it in the document hierarchy. The other format organizes the result set by unique Token, and the points in which that token appears. In another embodiment, concept tokens along with original point data and the specific algorithm which generated this token can be stored in a database or in memory for further processing. For different lexicon generation algorithms a token centric or sting centric approach (in one embodiment, the strings are point names and or point descriptions) is better for processing time so both formats are created in the combine tokens method. Also, a count of the number of strings which contain a particular token is maintained and can indicate a greater likelihood of that token being mapped to a known concept if the corresponding count is high, relative to other token counts.

The term used for a concept should be distinct within the whole set of terms. Lexicon creation defines a set of concept terminology that are potential matches for the concept tokens. One example includes the concept AirHandlingUnit, which is a probable match for the concept token AHU in the HVAC domain. For a given concept, restrictions can be placed on which other concepts can be included in a concept set. Restrictions may exclude concepts. (Example: The concept Chiller cannot be in the same set as the concept HotWater.Restrictions may explicitly declare acceptable concepts based on a given concept. (Example: If a concept set includes the concept ‘OutsideAir,’ the only concepts with type ‘DistributionElementType’ that may be included are ‘Damper’ and ‘Fan’). Semi-automatic lexicon generation may be performed such that the combined tokens are matched to concept terms using regular expression matching. Different regular expression algorithms may be used to provide varying levels of quality matches. Each match may be given a confidence level. The confidence level for a given algorithm can be assigned to the algorithm as a numeric value or a calculation.

Matches to concept sets from the ontology require evaluation of the logical rules stored in the ontology, and evaluation of the likelihood of the resulting solution sets can be based on the combined confidence of the tokens involved in completing the solution.

In one embodiment, the number of characters “left over”, or unused tokens in a complete string, provides another confidence score. For example, the more characters in an given string that were not employed to identify context, the lower the confidence score for that solution set.

In one embodiment, all terms of a given type being disjoint means that two concepts of the same type cannot both be included in a concept set. Example: AirHandlingUnit and RoofTopUnit are both of type PlantType so cannot be included in the same concept set. For a given concept, restrictions can be placed on which other concepts can be included in a concept set. Restrictions may exclude concepts. For example, the concept Chiller cannot be in the same set as the concept HotWater.

Restrictions may explicitly declare acceptable concepts based on a given concept. In one example, if a concept set includes the concept ‘OutsideAir,’ the only concepts with type ‘DistributionElementType’ that may be included are ‘Damper’ and ‘Fan’. A match to a concept set means that no ontology rules have been violated and that all the token-to-concept matches for a given string are valid within the concept set (Example: If the concept ExhaustAir is considered a match and the concept set being considered as a match does not contain ExhaustAir, then that concept set is NOT a match.)

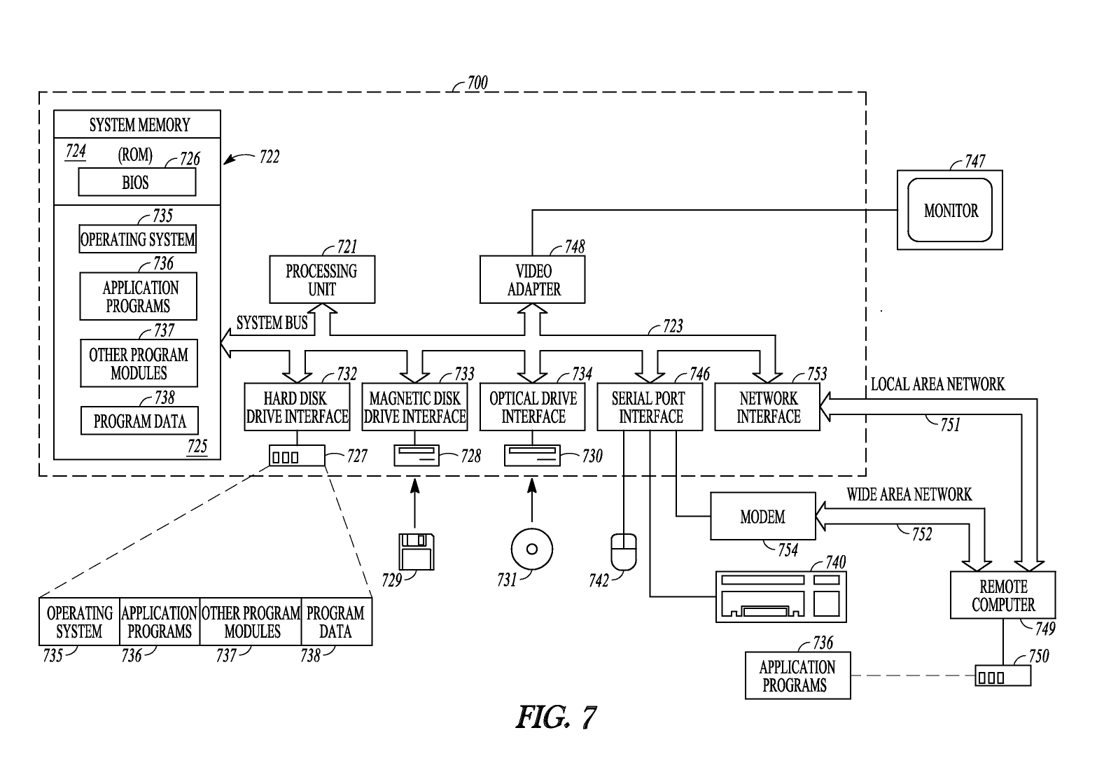

FIG. 7 is a block diagram of a computer system to implement methods according to an example embodiment. In the embodiment shown in FIG. 7, a hardware and operating environment is provided that is applicable to any of the servers and/or remote clients shown in the other Figures.

As shown in FIG. 7, one embodiment of the hardware and operating environment includes a general purpose computing device 700 (e.g., a personal computer, tablet, mobile device, workstation, or server), including one or more processing units 721, a system memory 722, and a system bus 723 that operatively couples various system components including the system memory 722 to the processing unit 721. There may be only one or there may be more than one processing unit 721, such that the processor of computer 700 comprises a single central-processing unit (CPU), or a plurality of processing units, commonly referred to as a multiprocessor or parallel-processor environment. In various embodiments, computer 700 is a conventional computer, a distributed computer, or any other type of system that processes information.

The system bus 723 can be any of several types of bus structures including a memory bus or memory controller, a peripheral bus, and a local bus using any of a variety of bus architectures. The system memory can also be referred to as simply the memory, and, in some embodiments, includes read-only memory (ROM) 724 and random-access memory (RAM) 725. A basic input/output system (BIOS) program 726, containing the basic routines that help to transfer information between elements within the computer 700, such as during start-up, may be stored in ROM 724. The computer 700 further includes a hard disk drive 727 for reading from and writing to a hard disk, not shown, a magnetic disk drive 728 for reading from or writing to a removable magnetic disk 729, and an optical disk drive 730 for reading from or writing to a removable optical disk 731 such as a CD ROM or other optical media.

The hard disk drive 727, magnetic disk drive 728, and optical disk drive 730 couple with a hard disk drive interface 732, a magnetic disk drive interface 733, and an optical disk drive interface 734, respectively. The drives and their associated computer-readable media provide non volatile storage of computer-readable instructions, data structures, program modules and other data for the computer 700. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 729, optical disk 731, ROM 724, or RAM 725, including an operating system 735, one or more application programs 736, other program modules 737, and program data 738. Programming for implementing one or more processes or method described herein may be resident on any one or number of these computer-readable media.

A user may enter commands and information into computer 700 through input devices such as a keyboard 740 and pointing device 742. Other input devices (not shown) can include a microphone, joystick, game pad, satellite dish, scanner, or the like. These other input devices are often connected to the processing unit 721 through a serial port interface 746 that is coupled to the system bus 723, but can be connected by other interfaces, such as a parallel port, game port, or a universal serial bus (USB). A monitor 747 or other type of display device can also be connected to the system bus 723 via an interface, such as a video adapter 748. The monitor 747 can display a graphical user interface for the user. In addition to the monitor 747, computers typically include other peripheral output devices (not shown), such as speakers and printers.

The computer 700 may operate in a networked environment using logical connections to one or more remote computers or servers, such as remote computer 749. These logical connections are achieved by a communication device coupled to or a part of the computer 700; the invention is not limited to a particular type of communications device. The remote computer 749 can be another computer, a server, a router, a network PC, a client, a peer device or other common network node, and typically includes many or all of the elements described above 110 relative to the computer 700, although only a memory storage device 750 has been illustrated. The logical connections depicted in FIG. 7 include a local area network (LAN) 751 and/or a wide area network (WAN) 752. Such networking environments are commonplace in office networks, enterprise-wide computer networks, intranets and the internet, which are all types of networks.

When used in a LAN-networking environment, the computer 700 is connected to the LAN 751 through a network interface or adapter 753, which is one type of communications device. In some embodiments, when used in a WAN-networking environment, the computer 700 typically includes a modem 754 (another type of communications device) or any other type of communications device, e.g., a wireless transceiver, for establishing communications over the wide-area network 752, such as the internet. The modem 754, which may be internal or external, is connected to the system bus 723 via the serial port interface 746. In a networked environment, program modules depicted relative to the computer 700 can be stored in the remote memory storage device 750 of remote computer, or server 749. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

### EXAMPLES

1. A computer readable storage device having a meta-data structure stored thereon consistent with a domain ontology, the data structure comprising:

multiple context elements to describe elements and their context within a system in the domain;

multiple role functions to describe the function of elements in the system in relation to other elements in the system;

multiple types to describe values being provided by the elements in the system; and

multiple states to describe states of the elements in the system, wherein the context elements, role functions, types, and states are selectable to provide a full description of the system.

2. The computer readable storage device of example 1 wherein the full description of a specific system describes the configuration and relative arrangement of the instances of the realized elements within that specific system, which can be validated against the meta-data structure.

3. The computer readable storage device of any of examples 1-2 wherein a subset of the full description is includeable in telemetry transmissions relating to the elements.

4. The computer readable storage device of any of examples 1-3 wherein the context elements include a containment context to describe allowed containment relationships of an element of one type by elements of the same type or other types, including a plant context to describe a subsystem and an equipment context to describe a specific type of device related to that subsystem.

5. The computer readable storage device of any of examples 1-4 wherein the role functions include a distribution role identifying a name of a function that is performed by an element or set of elements.

6. The computer readable storage device of any of examples 1-5 wherein the context elements include a material type, a measure type, a PID role type, a signal type, a static type, a limit type, and a state type.

7. The computer readable storage device of any of examples 1-6 wherein the states include a building state, an equipment state, and a point state.

8. The computer readable storage device of any of examples 1-7 where the context data is applied to define elements of a system when that system is being configured.

9. A method comprising:

obtaining a description of elements in an existing system;

identifying tokens from the description of the elements in the system;

comparing the tokens with a lexicon derived from a domain ontology for describing the system in that domain; and

mapping the tokens to specific roles utilizing rules of the domain-specific ontology.

10. The method of example 9 wherein identifying tokens comprises parsing a trie to build the tokens utilizing a children>X algorithm.

11. The method of any of examples 9-10 wherein identifying tokens comprises parsing a Trie to build concept tokens utilizing a traversal count algorithm.

12. The method of any of examples 9-11 wherein the system data structure comprises strings of characters from a character system

13. The method of any of examples 9-12 wherein identifying tokens comprises parsing a Trie to build concept tokens, wherein the Trie is processed in an iterative fashion to further reduce the set of unique tokens evidenced in the naming convention.

14. The method of any of examples 9-13 wherein the system data structure further comprises at least one of plant context, equipment context, distribution role, distribution role, equipment role, material type, point aspects, measure type, PIDrole type, signal type, signal direction, statistic type, limit type, and state type.

15. A system programmed to perform a method, the method comprising:

obtaining a description of elements in a system;

identifying tokens from the description of the elements in the system;

comparing the tokens with lexicons that are based upon an ontology for describing systems within a specific domain; and

mapping the tokens to specific roles utilizing rules of the domain-specific ontology.

16. The system of example 15 wherein identifying tokens comprises parsing a trie to build the tokens utilizing a children>X algorithm.

17. The system of any of examples 15-16 wherein identifying tokens comprises parsing a Trie to build concept tokens utilizing a traversal count algorithm.

18. The system of any of examples 15-17 wherein the system data structure comprises strings of characters from a character system.

19. The system of any of examples 15-18 wherein identifying tokens comprises parsing a Trie to build concept tokens, wherein the Trie is processed in an iterative fashion to further reduce the set of unique tokens evidenced in the naming convention.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer readable storage device having a meta-data structure stored thereon consistent with a domain ontology, the data structure comprising:
multiple context elements to describe elements and their context within a system in the domain;
multiple role functions to describe the function of elements in the system in relation to other elements in the system;
multiple types to describe values being provided by the elements in the system; and
multiple states to describe states of the elements in the system, wherein the context elements, role functions, types, and states are selectable to provide a full description of the system.

2. The computer readable storage device of claim 1 wherein the full description of a specific system describes the configuration and relative arrangement of the instances of the realized elements within that specific system, which can be validated against the meta-data structure.

3. The computer readable storage device of claim 1 wherein a subset of the full description is includeable in telemetry transmissions relating to the elements.

4. The computer readable storage device of claim 1 wherein the context elements include a containment context to describe allowed containment relationships of an element of one type by elements of the same type or other types, including a plant context to describe a subsystem and an equipment context to describe a specific type of device related to that subsystem.

5. The computer readable storage device of claim 1 wherein the role functions include a distribution role identifying a name of a function that is performed by an element or set of elements.

6. The computer readable storage device of claim 1 wherein the context elements include a material type, a measure type, a PID role type, a signal type, a static type, a limit type, and a state type.

7. The computer readable storage device of claim 1 wherein the states include a building state, an equipment state, and a point state.

8. The computer readable storage device of claim 1 where the context data is applied to define elements of a system when that system is being configured.

9. A method comprising:
obtaining a description of elements in an existing system;
identifying tokens from the description of the elements in the system;
comparing the tokens with a lexicon derived from a domain ontology for describing the system in that domain; and
mapping the tokens to specific roles utilizing rules of the domain-specific ontology.

10. The method of claim 9 wherein identifying tokens comprises parsing a trie to build the tokens utilizing a children>X algorithm.

11. The method of claim 9 wherein identifying tokens comprises parsing a Trie to build concept tokens utilizing a traversal count algorithm.

12. The method of claim 9 wherein the system data structure comprises strings of characters from a character system

13. The method of claim 9 wherein identifying tokens comprises parsing a Trie to build concept tokens, wherein the Trie is processed in an iterative fashion to further reduce the set of unique tokens evidenced in the naming convention.

14. The method of claim 9 wherein the system data structure further comprises at least one of plant context, equipment context, distribution role, distribution role, equipment role, material type, point aspects, measure type, PIDrole type, signal type, signal direction, statistic type, limit type, and state type.

15. A system programmed to perform a method, the method comprising:
obtaining a description of elements in a system;
identifying tokens from the description of the elements in the system;
comparing the tokens with lexicons that are based upon an ontology for describing systems within a specific domain; and
mapping the tokens to specific roles utilizing rules of the domain-specific ontology.

16. The system of claim 15 wherein identifying tokens comprises parsing a trie to build the tokens utilizing a children>X algorithm.

17. The system of claim 15 wherein identifying tokens comprises parsing a Trie to build concept tokens utilizing a traversal count algorithm.

18. The system of claim 15 wherein the system data structure comprises strings of characters from a character system

19. The system of claim 15 wherein identifying tokens comprises parsing a Trie to build concept tokens, wherein the Trie is processed in an iterative fashion to further reduce the set of unique tokens evidenced in the naming convention.
